(19) United States
(12) Patent Application Publication
(10) Pub. No.: US 2021/0333585 A1
(43) Pub. Date: Oct. 28, 2021

(54) DISPLAY PANEL PREPARATION METHOD AND COATING APPARATUS

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Chunge YUAN, Shenzhen (CN)

(73) Assignee: Shenzhen China Star Ootoelectronics Semiconductor Display Technology Co., Ltd., Shenzhen, Guangdong (CN)

(21) Appl. No.: 16/616,499

(22) PCT Filed: Jun. 11, 2019
(86) PCT No.: PCT/CN2019/090667

§ 371 Date: Nov. 25, 2019

(30) Foreign Application Priority Data
May 17, 2019 (CN) 201910412406.3

(51) Int. Cl. G02F 1/1339; G02F 1/1333; G02F 1/1341; G02F 1/13

(52) U.S. Cl. CPC G02F 1/1339; G02F 1/1303; G02F 1/13415; G02F 1/133351

(57) ABSTRACT

The invention provides a method of preparing a display panel and a coating apparatus. The method includes a base substrate arrangement step, a frame sealant layer preparation step, a liquid crystal layer preparation step, a color filter substrate bonding step, a curing step, and a cutting step. The frame sealant layer preparation step includes: a coating step, applying a liquid sealant to a periphery of each of array substrates; and a pre-curing step, performing a pre-curing to the liquid sealant by a curing light source to form the frame sealant layer. The coating apparatus includes a support frame, a nozzle, and a curing light source. The technical effect of the present invention is to prevent the flexible frame sealant layer from damage when relieving the vacuum, thereby avoiding scrapping of the display panel and improving yield of the display panel.

### FIELD OF INVENTION

The present invention relates to the field of display panel, and in particular, to a method for preparing a display panel and a coating apparatus.

### BACKGROUND OF INVENTION

Due to demands of smart driving, smart home appliances, portable devices, etc, flexible displays have attracted much attention at major exhibitions in recent years and are considered to be an important direction for display development in the future.

Development of flexible display panel technology is characterized by being bendable, curlable, and not easily damaged. In order to achieve flexibility, i.e., the bending property, it is necessary to use a flexible sealant. Because the brittleness of the flexible sealant is small, such that when the substrate is folded and bent, the sealant can also be folded and bent without cracking to cause technical problems such as damage of the display panel. Therefore, the sealant can increase the surface life of a flexible substrate.

In the TFT-LCD panel, a sealant is required when an array substrate and a color filter substrate are bonded into a cell. The functions of the sealant include: a bonding function, the sealant is used to fix the array substrate and the color filter substrate; a sealing function, the sealant is used to prevent liquid crystals from contacting with external moisture and impurities and avoiding the liquid crystals flowing out; and a support function, the sealant is used to coat a specific seal pattern to support a gap of the seal pattern.

Generally, a sealant is coated on an outer periphery of an overall substrate to support the gap around the overall substrate to prevent an upper substrate and a lower substrate from being attached and resulting in subsequent cutting and fragmentation issues. The primary sealant is applied to a periphery of each of the array substrate and functions as described above. However, due to its characteristics such as bendable and curlable, the flexible sealant is easily damaged by airflow in the subsequent vacuum relief process, causing the liquid crystals to flow out, which leads to a display panel damage.

### Technical Problem

The object of the present invention is to solve the technical problem that the flexible sealant of the current flexible display panel is easily broken by airflow in the time of vacuum relief, thereby causing the liquid crystal to flow out and damaging the display panel.

### SUMMARY OF INVENTION

In order to achieve the above object, the present invention provides a method for preparing a display panel, which in turn includes a base substrate arrangement step, a frame sealant layer preparation step, a liquid crystal layer preparation step, a color filter substrate bonding step, a curing step, and a cutting step; wherein the frame sealant layer preparation step includes: a coating step, applying a liquid sealant to a periphery of each of the array substrates; and a pre-curing step, performing a pre-curing treatment to the liquid sealant by a curing light source to form the frame sealant layer.

Further, the base substrate arrangement step includes forming two or more array substrates on a base substrate; the frame sealant layer preparation step includes preparing the frame sealant layer at the periphery of each of the array substrates to form frame sealant cavities; the liquid crystal layer preparation step includes dropping liquid crystals into each of the sealant cavities of the array substrates to form the liquid crystal layers encircled by the frame sealant layer; the color filter substrate bonding step includes vacuum bonding the color filter substrate to the liquid crystal layers; the curing step includes curing the frame sealant layer again by a curing light source and/or a heat source; and the cutting step includes cutting the base substrate to divide the base substrate into two or more display panels.

Further, including a peripheral sealant layer preparing step before the frame sealant layer preparation step, preparing the peripheral sealant layer at a periphery of the base substrate to form a peripheral sealant layer cavity, the array substrates are positioned in the peripheral sealant layer cavity.

Further, the curing light source includes one of an ultraviolet light source, an infrared light source, and a blue light source.

Further, in the frame sealant layer preparation step, the curing light source is disposed adjacent to a dispense head configured to apply the liquid sealant, and the curing light source and the dispense head are configured to move synchronously along an applying direction.

Further, the color filter substrate bonding step includes: a color filter substrate covering step, covering the liquid crystal layers with the color filter substrate; a vacuuming step, feeding the base substrate into a vacuum chamber and vacuuming the vacuum chamber to bond the color filter substrate to the liquid crystal layers; and an air introduction step, introducing the air into the vacuum chamber.

In order to achieve the above object, the present invention further provides a coating apparatus, including a support frame; a nozzle disposed at a side of the support frame; and a curing light source disposed at the side of the support frame where the nozzle is disposed.

Further, the curing light source includes one of an ultraviolet light source, an infrared light source, and a blue light source.

Further, the curing light source is disposed coaxially with the nozzle.

### Beneficial Effect

The technical effect of the invention is that the liquid sealant is pre-cured when applying to the liquid sealant so that the liquid sealant is initially cured to form a frame sealant layer. It prevents the frame sealant layer from damage by airflow in the subsequent color filter substrate bonding step, thereby avoiding the frame sealant layer collapse to cause an overflow of the liquid crystals from the frame sealant cavity, and further damaging the display panel. By pre-curing the liquid sealant, the hardness of the frame sealant layer is enhanced, the liquid crystal layer is protected, and the yield of the display panel is improved.

### DESCRIPTION OF DRAWINGS

FIG. 1 is a flowchart of a method for preparing the display panel according to an embodiment of the present invention.

FIG. 2 is a flowchart of the color filter substrate bonding step according to an embodiment of the present invention.

FIG. 3 is a top plan view of the base substrate according to an embodiment of the present invention.

FIG. 4 is a schematic structural diagram of the display panel according to an embodiment of the present invention.

FIG. 5 is a top plan view of the display panel according to an embodiment of the invention.

FIG. 6 is a schematic view showing the coating apparatus according to an embodiment of the present invention.

The reference numerals of components in the drawings are denoted as follows:

1: array substrate, 2: peripheral sealant layer, 3: frame sealant layer, 4: liquid crystal layer, 5: color filter substrate, 10: support frame, 20: nozzle, 30: curing light source.

### DETAILED DESCRIPTION OF PREFERRED EMBODIMENTS

The preferred embodiments of the present invention are described in detail following with reference to the accompanying drawings to certify the invention can be implemented and render the disclosed technical content of the invention clearer. Those skilled in the art will more readily understand how to implement the invention. However, the present invention may be embodied in different forms and embodiments, and the scope of the invention is not limited to the embodiments described herein.

The directional terms mentioned in the present invention, such as “upper”, “lower”, “front”, “rear”, “left”, “right”, “inside”, “outside”, “side”, etc., only represent the directions in the drawings. The directional terms used herein are used to explain the invention and are not intended to limit the scope of the invention.

In the drawings, structurally identical components are denoted by the same reference numerals, and structural or functionally similar components are denoted by similar reference numerals. Moreover, the size and thickness of each component shown in the drawings are arbitrarily shown for ease of understanding and description, and the invention does not limit the size and thickness of each component.

When a component is described as “on” the other component, the component may be placed directly on the other component; there may also be an intermediate component, the component is placed on the intermediate component and the intermediate component is placed on the other component. When a component is described as “mounted/connected” to the other component, it may be understood as the component is directly “mounted/connected” to the other component or “mounted/connected” to the other component by an intermediate component.

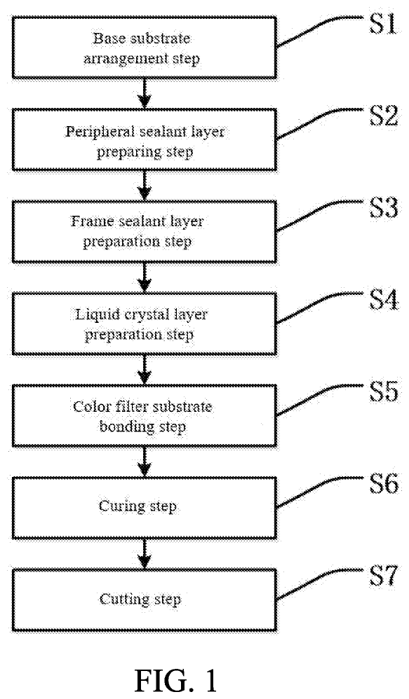

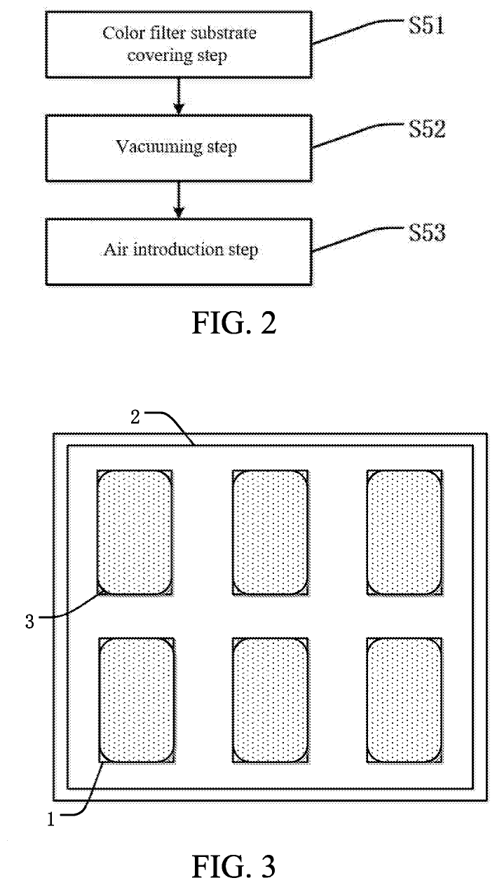

As shown in FIG. 1 to FIG. 6, the embodiment provides a method for preparing a display panel, includes the following steps S1 to S7.

Step S1: a base substrate arrangement step, forming two or more array substrates on a base substrate, and the two or more array substrates are arranged in a matrix.

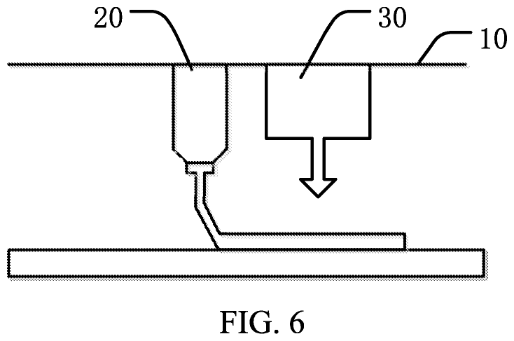

Step S2: a peripheral sealant layer preparing step, applying a liquid sealant at the periphery of the upper surface of the base substrate to form a peripheral sealant layer by using the coating apparatus described in FIG. 6. The peripheral sealant layer encircles to form a peripheral sealant layer cavity. All array substrates on the base substrate are positioned in the peripheral sealant layer cavity. During the coating process, the nozzle 20 is used to apply the liquid sealant, at which time the curing light source 30 is in a turn-off state.

The peripheral sealant layer plays a supporting role to support the base substrate to prevent an upper substrate and a lower substrate from attaching together during the subsequent bonding process, thereby avoiding a cutting abnormality issue in the subsequent cutting step.

Step S3: a frame sealant layer preparation step, the frame sealant layer is disposed at the periphery of each of the array substrates to form a frame sealant cavity. The frame sealant layer preparation step includes a coating step and a pre-curing step, and the coating step is performed in synchronization with the pre-curing step.

Using the coating apparatus described in FIG. 6, a nozzle 20 is used to apply the liquid sealant. At this time, a curing light source 30 is in a state of turn-on, the curing light source 30 and the nozzle 20 are disposed at the same side of the frame support 10, and the curing light source 30 is coaxial with the nozzle 20. When the nozzle 20 applies the liquid sealant, the curing light source 30 positioned behind cures the applied liquid sealant. The curing light source 30 includes one of an ultraviolet light source, an infrared light source, and a blue light source. The liquid sealant is preliminarily solidified to form a frame sealant layer which ensures that the frame sealant layer does not collapse. Thus, the frame sealant layer is not broken during the subsequent process.

In other embodiments, the curing source 30 is not coaxially provided with the nozzle 20.

The material of the frame sealant layer is a flexible sealant, which meets the requirements of the current flexible display panel. In the current preparation process of a display panel, the subsequent vacuum relief and curing steps are performed after the flexible sealant is applied, which causes the flexible sealant to be easily destroyed by the airflow, and leads to an outflow of the liquid crystal in the frame sealant cavity encircled by the frame sealant, such that the display panel is damaged. Therefore, in the embodiment, the applied liquid sealant is pre-cured to protect the frame sealant layer from damage.

Step S4: a liquid crystal layer preparation step, dropping liquid crystals into each of the sealant cavities of the array substrates to form the liquid crystal layers encircled by the frame sealant layer.

Step S5: a color filter substrate bonding step, vacuum bonding the color filter substrate to the liquid crystal layers, the color filter substrate bonding step specifically includes S51 to S53.

Step S51: a color filter substrate covering step, covering the liquid crystal layers with the color filter substrate. A size of the color filter substrate needs to be larger than that of the liquid crystal layer to ensure the liquid crystal layer is completely covered to avoid an outflow of the liquid crystal.

Step S52: a vacuuming step, feeding the base substrate into a vacuum chamber and vacuuming the vacuum chamber to completely bond the color filter substrate to the liquid crystal layers.

Step S53: an air introduction step, introducing the air into the vacuum chamber. In the air introduction step, because the frame sealant layer is preliminarily shaped after pre-curing, such that the frame sealant layer is not affected by airflow, and an outflow of the liquid crystal is avoided.

Step S6: a curing step, curing the frame sealant layer by ultraviolet curing method and heat curing method. The cured base substrate as shown in FIG. 3.

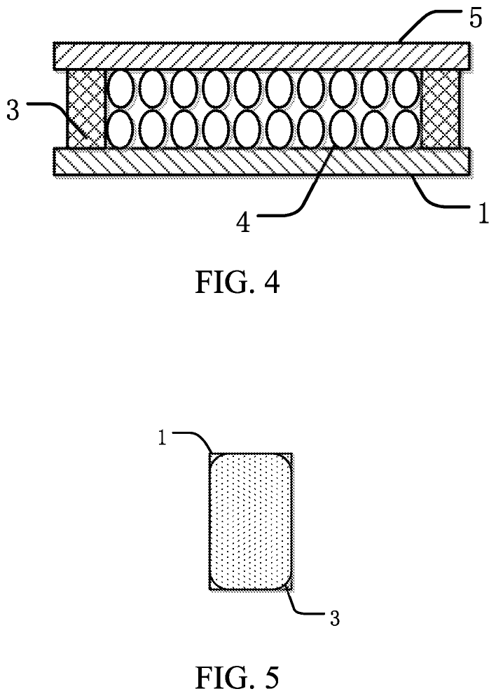

Step S7: a cutting step, cutting the base substrate to divide the base substrate into two or more display panels (refer to FIG. 4 to FIG. 5). Each array substrate 1 is disposed opposite to the color filter substrate 5, and the liquid crystal layer 4 is disposed in the frame sealant cavity encircled by the frame sealant layer 3.

The technical effect of the invention is that the liquid sealant is pre-cured when applying to the liquid sealant so that the liquid sealant is initially cured to form a frame sealant layer. It prevents the frame sealant layer from damage by airflow in the subsequent color filter substrate bonding step. Therefore, it avoids the frame sealant layer collapse to cause an overflow of the liquid crystals from the frame sealant cavity, and further damaging the display panel. By pre-curing the liquid sealant, the hardness of the frame sealant layer is enhanced, the liquid crystal layer is protected from damage, and the yield of the display panel is improved.

The description of the above exemplary embodiments is only for the purpose of understanding the invention. It is to be understood that the present invention is not limited to the disclosed exemplary embodiments. It is obvious to those skilled in the art that the above exemplary embodiments may be modified without departing from the scope and spirit of the present invention.

What is claimed is:

1. A method of preparing a display panel, comprising:
a base substrate arrangement step;
a frame sealant layer preparation step;
a liquid crystal layer preparation step;
a color filter substrate bonding step;
a curing step; and
a cutting step;
wherein the frame sealant layer preparation step comprises:
a coating step, applying a liquid sealant to a periphery of each of array substrates; and
a pre-curing step, performing a pre-curing to the liquid sealant by a curing light source to form the frame sealant layer.

2. The method of preparing the display panel according to claim 1, wherein the base substrate arrangement step comprises forming two or more array substrates on a base substrate; the frame sealant layer preparation step comprises preparing the frame sealant layer at the periphery of each of the array substrates to form frame sealant cavities; the liquid crystal layer preparation step comprises dropping liquid crystals into each of the frame sealant cavities of the array substrates to form the liquid crystal layers encircled by the frame sealant layer; the color filter substrate bonding step comprises vacuum bonding the color filter substrate to the liquid crystal layers; the curing step comprises curing the frame sealant layer again by the curing light source and/or a heat source; and the cutting step comprises cutting the base substrate to divide the base substrate into two or more display panels.

3. The method of preparing the display panel according to claim 1, further comprising a peripheral sealant layer preparing step before the frame sealant layer preparation step, preparing the peripheral sealant layer at a periphery of the base substrate to form a peripheral sealant layer cavity, the array substrates are positioned in the peripheral sealant layer cavity.

4. The method of preparing the display panel according to claim 1, wherein the curing light source comprises one of an ultraviolet light source, an infrared light source, and a blue light source.

5. The method of preparing the display panel according to claim 1, wherein in the frame sealant layer preparation step, the curing light source is disposed adjacent to a dispense head configured to apply the liquid sealant, and the curing light source and the dispense head are configured to move synchronously along an applying direction.

6. The method of preparing the display panel according to claim 1, wherein the color filter substrate bonding step comprises:
a color filter substrate covering step, covering the liquid crystal layers with the color filter substrate;
a vacuuming step, feeding the base substrate into a vacuum chamber and vacuuming the vacuum chamber to bond the color filter substrate to the liquid crystal layers; and
an air introduction step, introducing the air into the vacuum chamber.

7. A coating apparatus, comprising:
a support frame;
a nozzle disposed at a side of the support frame; and
a curing light source disposed at the side of the support frame where the nozzle is disposed.

8. The coating apparatus according to claim 7, wherein the curing light source comprises one of an ultraviolet light source, an infrared light source, and a blue light source.

9. The coating apparatus according to claim 7, wherein the curing light source is disposed coaxially with the nozzle.
